(19) United States
(12) Patent Application Publication
(10) Pub. No.: US 2023/0382402 A1
(43) Pub. Date: Nov. 30, 2023

(54) AIR DRAG MODEL ESTIMATION USING VISUAL INFORMATION

(71) Applicant: VOLVO TRUCK CORPORATION, Göteborg (SE)

(72) Inventors: Mikael ASKERDAL, Åsa (SE); Leo LAINE, Härryda (SE)

(73) Assignee: VOLVO TRUCK CORPORATION, Göteborg (SE)

(21) Appl. No.: 18/320,647

(22) Filed: May 19, 2023

(30) Foreign Application Priority Data
May 27, 2022 (EP) 22175819.6

(51) Int. Cl. B60W 40/10; B60W 40/02; G06V 20/56

(52) U.S. Cl. CPC B60W 40/1005; B60W 40/02; G06V 20/56; B60W 2555/20; B60W 2300/14

(57) ABSTRACT

A computer-implement method of estimating air drag for a vehicle combination is provided. The method includes detecting a change of an exterior shape of the vehicle combination to a new exterior shape. The method includes, in response to detecting such a change, and based on one or more images of the vehicle combination captured after the change, estimating a projected area function indicating a dependence of a projected frontal area of the vehicle combination having the new exterior shape on air-attack angle. The method includes using the estimated projected area function to update a crosswind-sensitive air drag model for the vehicle combination.

### TECHNICAL FIELD

The present disclosure relates to the field of (heavy) vehicle combinations and air drag. In particular, the present disclosure relates to estimation of an air drag model for the vehicle combination based on visual information provided by e.g. one or more images of the vehicle combination.

### BACKGROUND

When driving in crosswind conditions, the air drag force acting on heavy vehicle combinations depend on the angle of air-attack. To take such air drag into account when for example estimating a power needed to propel the vehicle combination, an air drag model is used which expresses the air drag force Fₐ as a function of various parameters such as air density ρ, the drag coefficient C_{d} of the vehicle combination, the projected area Aₚ of the vehicle combination, and e.g. the axial/longitudinal air speed vₐₓ. To account for crosswinds/sidewinds, the drag coefficient and/or the projected (frontal) area of the vehicle combination are assumed to depend on air-attack angle θ.

To find the correct parameters for such an air drag model, wind tunnel tests are often used. Instead of finding the drag coefficient C_{d}(θ) and projected area Aₚ(θ) independently, it is often more convenient to estimate a joint drag area parameter [C_{d}A](θ). Wind tunnel experiments/tests may also be complemented by, or even replaced by, advanced numerical simulations (such as e.g. those based on Computational Fluid Dynamics, CFD).

The model parameters obtained from wind tunnel experiments are however only relevant as long as the exterior shape of the vehicle combination used in the wind tunnel experiments is not changed. As soon as the exterior shape of the vehicle combination changes, new wind tunnel tests and/or new numerical simulations are often required in order for the models to still remain as valid as before. As such wind tunnel tests and/or numerical simulations are often both tedious and costly, and in some situations not even feasible, the only remaining solution to find an air drag model for a new vehicle combination (having a new exterior shape) may be to perform so-called online estimation of the air drag model which includes measuring one or more relevant parameters while the vehicle combination is driving. To also estimate how the drag area depends on air-attack angle, on-line estimation techniques require access to accurate wind information while driving the vehicle combination, in order to properly capture the crosswind sensitivity of the drag area. In order for such on-line estimation to be valid, detailed knowledge about the wind that is actually affecting the vehicle combination must be known, and such knowledge may also be disturbed by e.g. various chaotic behavior of the wind caused by e.g. other vehicles driving on the same stretch of road, or similar.

A problem with the above is that a configuration of a vehicle combination will often change during a particular transport mission, i.e. by adding or removing one or more trailers or other towed vehicle units at some points along the planned route. A driver may for example be assigned the task of picking up a first trailer at point A, deliver the first trailer to point B, and then return back with another, second trailer from point B. By not knowing how to maintain a valid air drag model of the vehicle also after having changed the exterior shape, calculations (such as for energy management, cruise control, range prediction, etc.) which rely on an access to such a valid air drag model may therefore suffer.

There is therefore a need for an improved way of estimating air drag of/for a vehicle combination in situations when the exact configuration (e.g. the exterior shape) of the vehicle combination does not remain constant throughout a mission.

### SUMMARY

To at least partially satisfy the above-identified need, the present disclosure provides an improved (computer-implemented) method of estimating air drag of a vehicle combination, as well as a corresponding device, vehicle or vehicle combination, computer program and computer program product as defined by the accompanying independent claims. Various embodiments of the method, device, vehicle or vehicle combination, computer program and computer program product are defined by the accompanying dependent claims.

The method includes detecting a change of an exterior shape of the vehicle combination to a new exterior shape (i.e. a change from a previous exterior shape to the new exterior shape). The method further includes, in response to detecting such a change (of the exterior shape of the vehicle), and based on one or more images of the vehicle combination captured after the change of the exterior shape (to the new exterior shape), estimating a projected area function Aₚ(θ) indicating a dependence of a projected frontal area of the vehicle combination having the new exterior shape on air-attack angle θ. The method also includes using the estimated projected area function to update a crosswind-sensitive air drag model (i.e. a model depending on the air-attack angle θ) for the vehicle combination.

The vehicle combination envisaged herein is e.g. a heavy vehicle combination, such as a utility vehicle combination including e.g. a towing unit and one or more trailers (towed units). That the estimated projected area function is used to “update a crosswind-sensitive air drag model” means that the crosswind-sensitive air drag model is such that it requires knowledge about such a function, and that any previously used such function is replaced by the (newly) estimated projected area function. Examples of such an air drag model will be provided further below in the detailed description.

The present disclosure, and the envisaged method, improves upon currently available technology in that it, by using images of the vehicle combination, allows to determine the projected area function and to update the air drag model also when the exact shape of e.g. an added trailer is not known, where e.g. tabulated values for the exact combination of towing and towed units of the vehicle combination after the change are not available or existing, and without the need for expensive and/or cumbersome wind tunnel experiments and/or numerical simulations. In addition, the envisaged method further facilitates the process in that it automatically detects the occurrence of the change, and thereafter take appropriate action to update the air drag model. This may e.g. help to unload some of the burden from the driver, and allow the driver to instead focus on other things such as driving the vehicle in a safe way.

In some embodiments of the method, the method may include initiating (e.g. causing a triggering of) a capture of the one or more images in response to the detecting. By so doing, the method may e.g. proceed without the need for the driver to intervene. Initiating the capture of the one or more images may for example be performed by sending a control signal to one or more cameras used to capture the one or more images. As will be explained later herein in more detail, one or more images of the vehicle combination can also be used for the detection itself, e.g. by comparing how the vehicle combination looks in one image with how the vehicle combination looks in another image, in order to detect whether the configuration (and thereby possibly also the exterior shape) of the vehicle combination has changed between the images. In this case, if the detecting initiates (e.g. triggers) the capturing of the one or more images used to estimate the projected area function, the one or more images used to detect the change are not the same one or more images used to estimate the projected area function. In other embodiments, the same one or more images used for detection of the change can also be the one or more images used to estimate the projected area function. Phrased differently, in some embodiments of the method, the method may further include detecting the change of the exterior shape based on the one or more images of the vehicle combination (i.e. based on the same one or more images used to estimate the projected area function). In such embodiments, no further capturing of images may sometimes be needed, and in an optimal case a single image may suffer both for detecting the change and for estimating the projected area function.

In some embodiments of the method, the method may include receiving the one or more images (used to estimate the projected area function) from at least one camera. The at least one camera may be mounted to/on the vehicle combination (e.g. to a towing unit of the vehicle combination). For example, the at least one camera may be a digital rearview camera, a digital sideview (mirror) camera, camera mounted on the roof of the towing unit and facing backwards towards the one or more trailers, or similar. In other embodiments, the one or more images may instead be received e.g. from a smartphone, a camera equipped drone/UAV, a speed camera at a route along which the vehicle combination is driving, a road toll camera, a camera used to detect overloading of heavy vehicles, a traffic camera used to assess a traffic situation along the route the vehicle combination is driving, or any other camera with which the device/computer in charge of performing the envisaged method may communicate to exchange such one or more images.

In some embodiments of the method, estimating the projected area function may include estimating a side area of the vehicle combination after the change of the exterior shape. The estimated side area may be provided as a parameter to the crosswind-sensitive air drag model. As generally used herein, a “side area” of a vehicle or vehicle combination is a side of the vehicle or vehicle combination which is not a front, rear, top or bottom side. Phrased differently, a “side area” is a surface area of a lateral side of the vehicle or vehicle combination, and can be a left side or a right side of the vehicle or vehicle combination.

In some embodiments of the method, the one or more images may depict at least part of a side of the vehicle combination. In particular, the one or more images may depict at least a side part of e.g. an added trailer.

In some embodiments of the method, estimating the projected area function may include estimating the projected frontal area after the change of the exterior as a projected area of a cuboid on a plane perpendicular to air-attack. Two opposite faces of this cuboid may e.g. correspond to the front and back of the vehicle combination, two other opposite faces of the cuboid may correspond to the two (lateral) left/right sides of the vehicle combination, and two other opposite faces of the cuboid may e.g. correspond to the top and bottom of the vehicle combination. Phrased differently, the cuboid may be used to approximate an overall outer shape of the vehicle combination. The projected area may for example be a parallelly projected area.

In some embodiments of the method, detecting the change of the exterior shape may include at least one of receiving a signal from a user interface (such as e.g. when the user/driver pushes a button, selects/accesses/enters a particular menu option, or similar), receiving a signal indicative of a change in air deflector settings, and receiving a signal indicative of a trailer being either connected or detached from the vehicle combination. The detection of the change may e.g. be performed in combination with one or more sensors (or similar) available already for other purposes.

In some embodiments of the method, the method may further include receiving a predicted wind information pertinent to a particular route, and using the updated air drag model for at least one of energy management, range estimation, vehicle combination dynamics, and cruise control, of/for the vehicle combination along the particular route. Knowledge of both the predicted wind (e.g. speed and direction) along a route which the vehicle combination is to drive may, in combination with the updated air drag model, be used to e.g. predict an energy consumption of the vehicle combination, and/or to control the speed of the vehicle combination such that both energy and time needed to reach a destination are minimized in a multi-objective fashion. Such optimization may also be performed based on various user preferences. For example, there may be certain energy consumption constraints provided and travelling time may be optimized (e.g. minimized) subject to such constraints. Likewise, a desired travelling time may be provided in advance, and the energy consumption may be optimized (i.e. minimized) subject to such a desired travelling time.

According to a second aspect of the present disclosure, a device for estimating air drag of a vehicle combination is provided. The device includes processing circuitry configured to cause the device to: detect a change of an exterior shape of the vehicle combination to a new exterior shape; in response to said detection, based on one or more images of the vehicle combination captured after the change of the exterior shape (to the new exterior shape), estimate a projected area function (Aₚ(θ)) indicating a dependence of a projected frontal area of the vehicle combination having the new exterior shape on air-attack angle (θ), and, use the estimated projected area function to update a crosswind-sensitive air drag model for the vehicle combination. The device may thus be configured to perform the method of the first aspect.

In some embodiments of the device, the processing circuitry may be further configured to cause the device to perform any embodiment of the method according envisaged and described herein.

According to a third aspect of the present disclosure, a vehicle or vehicle combination is provided. The vehicle or vehicle combination includes a device according to the second aspect (or any embodiments thereof), configured to perform a method according to the first aspect (or any embodiments thereof).

In some embodiments of the vehicle or vehicle combination, the vehicle or vehicle combination may include one or more cameras configured to capture and provide the one or more images used to estimate the projected area function, and/or used to detect the change of the exterior shape of the vehicle. As mentioned before, such one or more cameras may e.g. be digital rear view, side view, back up, and or overall monitoring cameras capable of capturing images of the trailers of the vehicle combination. In the envisaged method, device and vehicle or vehicle combination, it may for example be envisaged that it is easier to capture pictures of the full vehicle combination when the vehicle combination is e.g. turning (in a corner, in a circulation point/roundabout, or similar), compared to when the vehicle combination is driving in a straight line.

According to a fourth aspect of the present disclosure, a computer program for estimating air drag of a vehicle combination is provided. The computer program includes computer code that, when running on processing circuitry of a device (such as the device of the second aspect or embodiments thereof, e.g. when included as part of the vehicle combination), causes the device to: detect a change of an exterior shape of the vehicle combination to a new exterior shape; in response to said detection, based on one or more images of the vehicle combination captured after the change of the exterior shape, estimate a projected area function (Aₚ(θ)) indicating a dependence of a projected frontal area of the vehicle combination having the new exterior shape on air-attack angle (θ), and, use the estimated projected area function to update a crosswind-sensitive air drag model for the vehicle combination. The computer program is thus such that it causes the device to perform a method according to the first aspect.

In some embodiments of the computer program, the computer code may be further such that it, when running on the processing circuitry of the device, causes the device to perform any embodiment of the method as envisaged herein.

According to a fifth aspect of the present disclosure, a computer program product is provided. The computer program product includes a computer-readable storage medium on which the computer program is stored. In some embodiments of the computer program product, the storage medium may be non-transitory.

Other objects and advantages of the present disclosure will be apparent from the following detailed description, the drawings and the claims. Within the scope of the present disclosure, it is envisaged that all features and advantages described with reference to e.g. the method of the first aspect are relevant for, apply to, and may be used in combination with also any feature and advantage described with reference to the device of the second aspect, the vehicle (combination) of the third aspect, the computer program of the fourth aspect, and the computer program product of the fifth aspect, and vice versa.

### BRIEF DESCRIPTION OF THE DRAWINGS

Exemplifying embodiments will now be described below with reference to the accompanying drawings, in which:

FIG. 1 schematically illustrates flows of various embodiments of a method of estimating air drag according to the present disclosure;

FIGS. 2A through 2D schematically illustrate various examples of one or more images which may be used to estimate a projected area function according to various embodiments of a method of air drag estimation according to the present disclosure, FIG. 3A schematically illustrates a towing unit in a top-view, and

FIGS. 3B through 3C schematically illustrate how a projected (frontal) area function and side area of a vehicle combination may be estimated, according to various embodiments of the present disclosure, FIG. 3D schematically illustrates a towing unit with an additional trailer in a top-view, and

FIGS. 4A and 4B schematically illustrate various embodiments of a device (for air drag estimation) according to the present disclosure.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested. As illustrated in the Figures, the (absolute or relative) sizes of elements and regions may be exaggerated or understated vis-à-vis their true values for illustrative purposes and, thus, are provided to illustrate the general structures of the embodiments.

### DETAILED DESCRIPTION

In what follows, the terms “vehicle” and “vehicle combination” will be used interchangeably, if not explicitly stated to the contrary. The same applies to the terms “wind” and “air” which, if not stated to the contrary, will be used interchangeably as well.

The present disclosure envisages that when a vehicle combination moves/drives relative to the surrounding wind/air, a resulting air drag force Fₐ affecting the vehicle combination may be approximated as

Fₐ≈0.5ρ[C_{d}A](θ)vₐₓ², (1)

where ρ is air density, [C_{d}A](θ) is the drag area (the combined drag coefficient and frontal area of the vehicle combination) as a function of air-attack angle θ, and vₐₓ is the axial/longitudinal air speed.

For many transport missions, the driver may be expected to pick-up and/or drop-off one or more vehicle units (such as e.g. trailers) along the way, and such changes to the exterior shape of the vehicle may thus affect the drag area of the vehicle combination. As the drag area influences the air drag force Fₐ, and as the air drag force Fₐ influences how hard e.g. the propulsion system of the vehicle combination must work to overcome the resistance caused by such air drag, operations such as predicting a fuel/energy consumption of the vehicle combination when driving is thus difficult if no updated air drag model can be provided. As discussed earlier herein, there are techniques available for using on-line estimation of the parameters in the air drag model, but as these techniques require knowledge about the actual air (including any turbulence and chaotic air movements caused by e.g. other vehicles), such techniques may be less reliable.

How the present disclosure solves the above problem will now be described in more detail with references to the drawings. The figures of these drawings show exemplifying embodiments of an envisaged improved method, device, and vehicle/vehicle combination, and also serve to illustrate the concepts of an improved computer program and computer program product as also envisaged herein. The drawings show currently preferred embodiments, but the invention may, however, be embodied in many different forms and should not be construed as limited to the embodiments set forth herein; rather, these embodiments are provided for thoroughness and completeness, and fully convey the scope of the present disclosure to the skilled person.

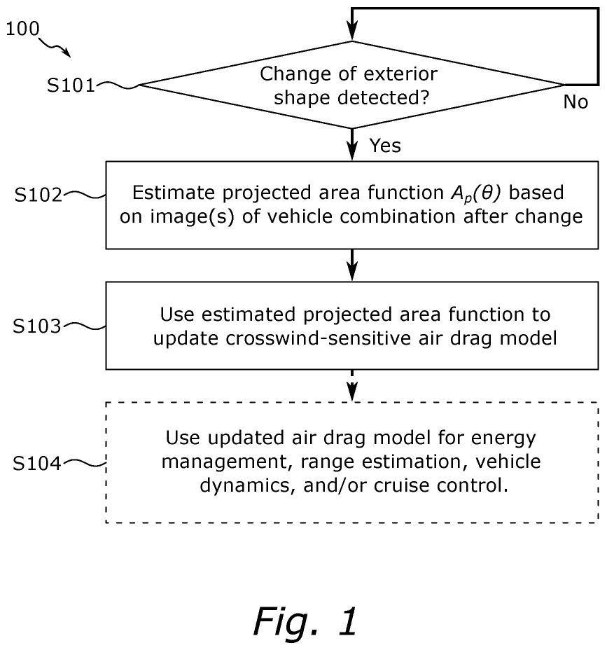

To illustrate the proposed method, reference is first made to FIG. 1, which schematically illustrates a flow of an envisaged method 100. In a first step S101, the method 100 includes detecting whether there has been a change to the exterior shape of the vehicle combination. For example, the step S101 may include detecting whether a trailer has been added and/or removed to the vehicle combination, resulting in a change of the exterior shape. The change may e.g. be detected by using one or more cameras monitoring the vehicle combination and, in combination with image analysis algorithms suitable for this purpose, detect changes to the vehicle combination visually. Other examples of how to detect the change may include e.g. a user/driver pressing a button, entering/activating a particular menu option in a user interface of the vehicle combination. A still further example may include e.g. detecting whether a trailer is connected or detached from the vehicle combination (using e.g. a sensor positioned at the “fifth wheel” in case of a semi-trailer, and/or a sensor positioned at e.g. a hook used to attach/detach a trailer, or similar. Other options may include e.g. checking whether air deflector settings changes, if it is envisaged that such deflectors are configured to adapt to optimize an air flow around the vehicle combination in terms of driving efficiency. Other means of detecting if there is a change in the exterior shape of the vehicle combination are of course also possible.

If the outcome of the detection step S101 is positive (“yes”), the method 100 proceeds to a step S102. If the outcome of the detection step S101 is negative (“no”), the method 100 may repeat back to step S101 and once again check whether a change of the exterior shape is made or not. In the step S102, in response to the detection in step S101, the method 100 uses on one or more images of the vehicle combination to estimate a projected area function Aₚ(θ), which indicates a dependence of a projected frontal area of the vehicle combination having the new exterior shape on air-attack angle (θ). Further details about how such an estimation may be performed will be provided later herein.

In a step S103, the method 100 uses the estimated projected area function to update a crosswind-sensitive air drag model for the vehicle combination. For this step, the air drag model provided by equation (1) can be used, with the newly estimated projected area function Aₚ(θ) replacing any older and previously used such function.

After having estimated the (new) projected area function Aₚ(θ) and updated the air drag model, the method 100 may optionally proceed to a step S104 in which the updated air drag model is then used for one or more computations performed in the vehicle combination, wherein these one or more computations all rely on having access to an accurate air drag model. Examples may include e.g. energy management, range estimation, vehicle combination dynamics (including e.g. vehicle combination stability in stronger crosswinds, or similar), and e.g. cruise control. Other computations which may utilize the updated air drag model (as provided by the present disclosure) are of course also possible, but not described in more detail herein.

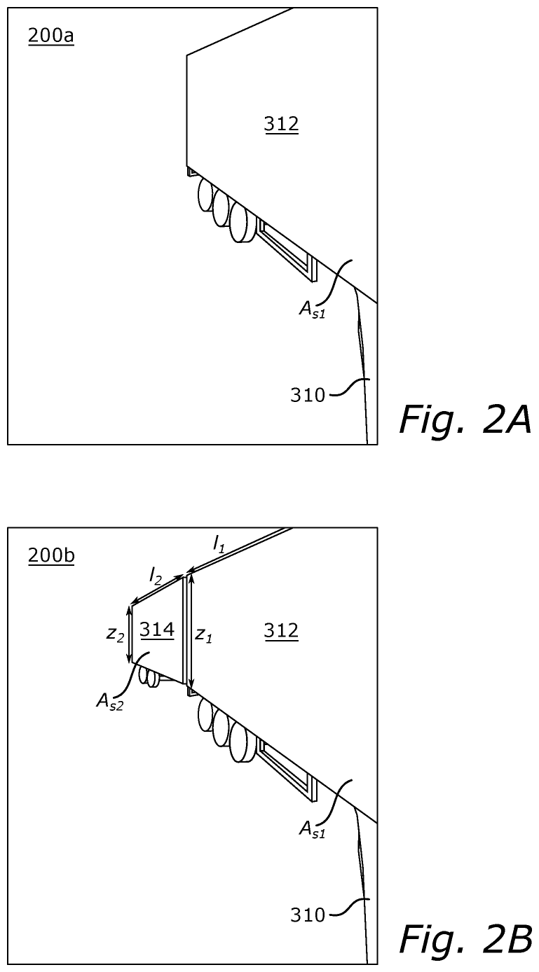

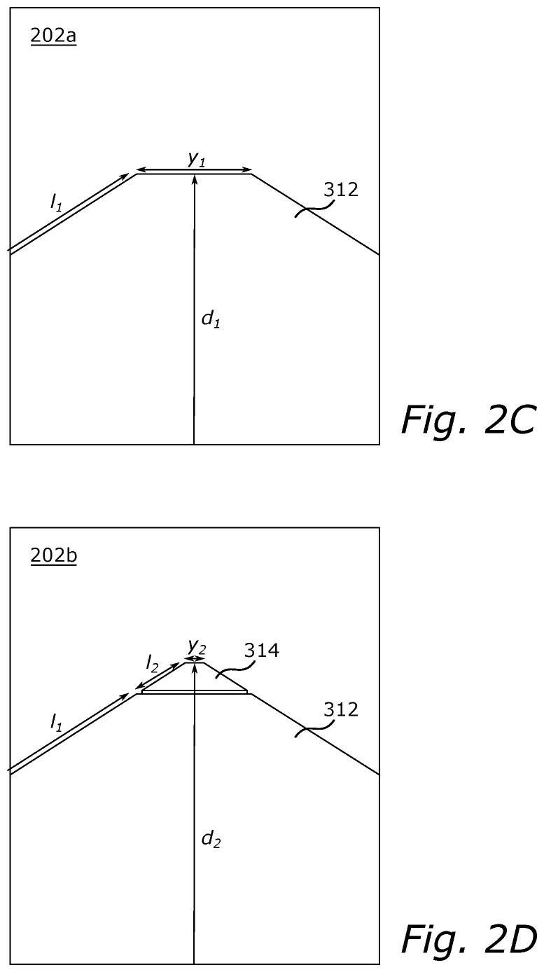

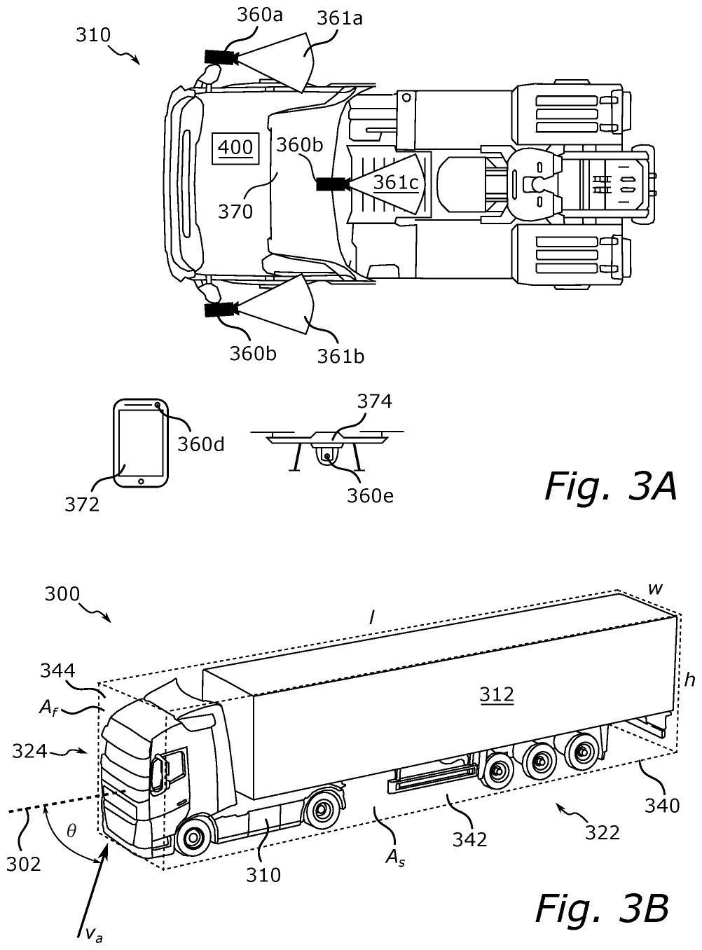

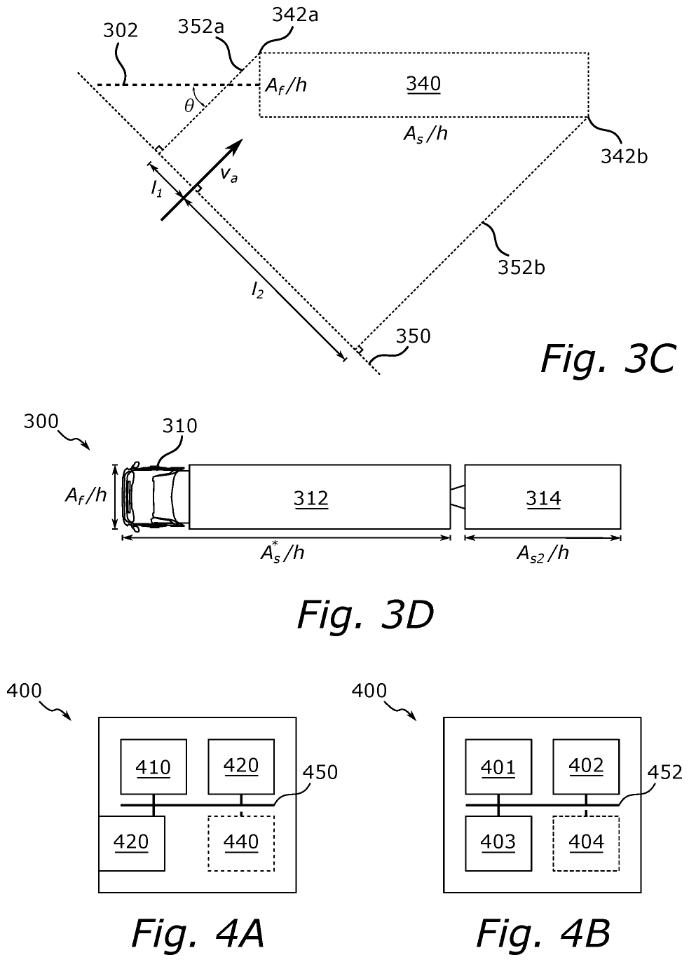

Various examples of how images of the vehicle combination can be used to estimate the projected area function Aₚ(θ) of the vehicle combination, will now be described in more detail with reference also to FIGS. 2A through 2D, and FIGS. 3A through 3D.

FIGS. 2A and 2B schematically illustrate example images 200a and 200b of a vehicle combination captured by a camera, such as e.g. a digital sideview (mirror) camera. The vehicle combination shown in image 200a includes a towing unit (e.g. a tractor unit) 310 and one trailer 312. Phrased differently, the vehicle combination shown in image 200a is a semi-trailer, wherein the trailer 312 is connected to the tractor unit 310 using a “fifth wheel”. The trailer 312 has a side area Aₛ₁, which can e.g. be assumed to be known already. For the purpose of the present example, the vehicle combination shown in image 200a is assumed to be the vehicle combination before any change to the exterior shape of the vehicle combination is made. In image 200a, the vehicle combination is currently turning slightly to the right, as can be seen by the finite articulation angle between the tractor unit 310 and the trailer 312.

FIG. 200b shows the vehicle combination at a later time instance. Now, a change of the exterior shape of the vehicle combination has been made, by adding an additional trailer 314 behind the trailer 312. As envisaged herein, such a change may e.g. be detected by using image analysis to detect e.g. a number of connected trailers in each image 200a and 200b, and to note when the number of connected trailers changes. The change may e.g. also be detected by receiving a signal from the means used to connect the additional trailer 314 to the trailer 312, or similar.

The proposed method envisages that a side area Aₛ₂ of the additional trailer is not known beforehand, but can be estimated from the image 200b. Such a procedure may e.g. include establishing a reference measure in the image 200b, i.e. at least one known distance/measure. For example, if a height h₁ of the trailer 312 is known in real life, measuring the distance z₁ in image 200b (e.g. by counting a number of pixels) allows to find such a reference measure. It is further assumed that other parameters relevant to the capturing of the image 200b are also known. Such other parameters include e.g. a size of an image sensor in the camera used to capture the image 200b (or e.g. a crop-factor and aspect ratio), a focal length of a lens used to capture the image 200b, information about a position of the camera used to capture the image 200b relative to the vehicle combination, and information about various articulation angles between e.g. the first trailer 312 and the tractor unit 310 and between e.g. the additional, second trailer 314 and the first trailer 312. It can also be assumed that a height h₂ of the additional trailer 314 is also similar or equal to the first trailer 312 (which is often the case). In other situations, it is assumed that also the height h₂ of the additional trailer 314 can also be estimated from the image 200b. If for example being able to estimate, from the image 200b and the above-mentioned other parameters, the length l₂ of the additional trailer 314, the side area Aₛ₂ of the additional trailer 314 can then be estimated simply as Aₛ₂=h₂×l₂. In any case, it is herein assumed that conventional technology for obtaining real-life dimensions of an object from an image depicting the object can be used for this purpose, and that the skilled person is confident in finding and applying such procedures as required.

In addition to the above, it is envisaged that also one or more homographies may also be constructed/estimated in order to account for e.g. perspective distortion or similar, to facilitate determining a side surface area of a vehicle unit (or vehicle combination) based on images capturing at least part of the side surface from an angle (such as e.g. when capturing one or more images of the side of the vehicle combination using rearview and/or sideview mirror cameras, or similar).

FIGS. 2C and 2D schematically illustrates another example of using images of the vehicle combination to estimate the side area Aₛ₂ of an additional trailer 314. Here, the camera used to capture images of the vehicle combination is mounted on top of the vehicle combination, e.g. on a spoiler of the towing unit 310, and faces backwards such that the top of any trailers connected to the towing unit 310 are at least partially visible in the images. FIG. 2C shows an image 202a wherein a single trailer 312 is added to the towing unit 310, just as in FIG. 2A. It will here be assumed that a real-life width w₁ of the trailer 312 is known, as well as e.g. a real-life length l₁ of the trailer 312. In another example, the length l₁ may be obtained by estimating the distance d₁ in the image 202a, and to use knowledge about e.g. the position of the camera relative to the vehicle combination to find l₁ based on d₁. In the situation depicted in FIGS. 2C and 2D, the vehicle combination is currently driving in a straight line, and the task of estimating various parameters are therefore easier than the situation depicted in FIGS. 2A and 2B (where the vehicle combination was turning, and the articulation angles were finite).

FIG. 2D shows an image 202b captured at a later time instance, where the additional trailer 314 has been added. As mentioned earlier, using image analysis and comparing the contents of the images 202a and 202b can be used to detect when the additional trailer 314 is added. Now, if the length l₁ of the trailer 312 is known, estimating the length l₂ of the additional trailer becomes a problem of estimating a distance from the camera used to capture the image 202b to the end of the additional trailer 314. If having knowledge about the size of the image sensor of the camera (or a crop-factor and aspect ratio), a focal length of the lens, and by measuring the distance y₂ in image 202b (i.e. by counting pixels), the distance d₂ from the camera to the end of the additional trailer 314 can be estimated using known procedures. By e.g. subtracting the distance d₁ from the distance d₂, and by assuming that the gap between the trailers 312 and 314 is small, an approximation of l₂ can thus be obtained. Once l₂ is known, and by assuming that e.g. a height h₂ of the additional trailer 314 matches a known height h₁ of the first trailer 312, the side area of the additional trailer 314 is given simply as Aₛ₂=h₂×l₂. In summary, using any of the methods described with reference to FIGS. 2A through 2D, it is envisaged that an estimation of the side area Aₛ₂ of the additional trailer (causing the change in the exterior shape of the vehicle combination) can be obtained from the images of the vehicle combination.

In general, the method as envisaged herein assumes that a known reference measure can be provided. For example, in an image captured such that it shows the vehicle combination from the side, the height of e.g. a trailer may be known and used as such a reference. The length of the vehicle combination, and in particular the length of a recently added trailer, can then be measured directly in such a side-view image. For example, if a trailer is measured as being 500 pixels high in the image and the vehicle combination is measured as being 2500 pixels long, the length of the vehicle combination (after the change) can be estimated as 2500/500×h, where h is a known height of the trailer being 500 pixels high. In a similar way, it is possible to calculate other measures. As shown with reference to FIGS. 2A and 2B, such calculations may be more complicated if the image does not depict the vehicle combination from the side, but e.g. as captured by a digital side view mirror or similar. In such a situation, information about e.g. articulation angles, camera parameters, camera orientation and placement relative to the vehicle combination, etc., may also be required before being able to calculate the necessary parameters needed to estimate the projected area function Aₚ(θ).

FIG. 3A schematically illustrates a towing unit 310 in a top-view. The towing unit 310 is here a tractor unit configured to form part of a semi-trailer combination, where the trailer (not shown) is connected to the towing unit 310 using a “fifth wheel” 311. In other examples, the towing unit 310 may instead be a truck, wherein a trailer can be added using a tow hitch and drawbar coupling. FIG. 3A illustrates various examples of how one or more cameras 360a-c may be provided on the towing unit 310. The cameras 360a-c are all facing backwards, such that each of their respective fields-of-view (FOVs) 361a-c captures at least part of the trailer(s) of the vehicle combination. For example, the towing unit 310 may be equipped with one or more cameras 360a and 360b acting as sideview mirrors. The cameras 360a and 360b may for example be configured to replace the traditional sideview mirrors, or may be provided in addition (as a compliment) to the traditional sideview mirrors. The camera 360c may be provided on top of the towing unit 310 such that it may capture a top of the one or more trailers attached to the towing unit 310. For example, the camera 360c may be provided on top of a spoiler (370) of the towing unit 310. It is of course envisaged that the exact number of cameras may vary. For example, only one, two or all of the cameras 360a-c may be provided. There may of course also be one or more other cameras provided than the cameras 360a-c, and configured such that they capture other angles of the one or more trailers attached to the towing unit 310.

In other embodiments of e.g. a method as envisaged herein, the one or more images of the vehicle combination may instead (or in addition) be captured by cameras provided elsewhere, such as a camera 360d forming part of a tablet or smartphone 372, or even as a camera 360e forming part of a drone/UAV 374. It is envisaged that as long as a device 400 responsible for carrying out the method 100 may communicate with such cameras in order to receive the one or more images of the vehicle combination, it is not critical in what way, and/or by what camera, the one or more images are captured. The device 400 may, as illustrated in FIG. 3A, for example form part of the vehicle/towing unit 310, but may also (instead) form part of e.g. a trailer, the tablet/smartphone 372, or similar equipment including processing circuitry configured to carry out the envisaged method 100. Other examples of cameras that may be used to capture the one or more images of the vehicle combination include e.g. speed cameras, traffic monitoring cameras, road toll cameras, cameras installed on gas-stations or resting places for truck drivers, cameras installed at weighing stations, or similar.

How knowledge about the side area Aₛ₂ of the added trailer 314 can be used to estimate the projected area function Aₚ(θ) will now be described in more detail with reference in particular to FIGS. 3B through 3D.

FIG. 3B schematically illustrates a vehicle combination 300 driving in a situation where air attacks the vehicle at an angle θ, where θ is measured as the angle between an air vector vₐ and a longitudinal direction/axis of the vehicle combination (as indicated by the dashed line 302). The air vector vₐ points in the direction of air attack at the current location of the vehicle combination 300, and has a magnitude proportional to air speed.

Before the change of the exterior shape, the vehicle combination 300 has a previous projected area function A*ₚ(θ) (where the asterisk * is used to denote a “previous” value/function), and the change of the exterior shape (e.g. the addition or removal of one or more trailers) changes the projected area function to a new projected area function Aₚ(θ). In the present disclosure, it is assumed that being able to estimate this new projected area function Aₚ(θ) from one or more images of the vehicle combination 300 is required in order to also estimate a new cross-wind sensitive drag area [C_{d}A](θ) of the vehicle combination 300, as the drag area [C_{d}A](θ) forms part of the air drag model of the vehicle combination 300 as provided by equation (1).

The drag area [C_{d}A](θ) may for example be estimated as

[C_{d}A](θ)≈c₁A_{p(θ)}, (2a)

[C_{d}A](θ)≈(c₁+c₂ tan(θ))Aₚ(θ), (2b)

[C_{d}A](θ)≈(c₁+c₃ tan² (θ))Aₚ(θ), (2c)

or

[C_{d}A](θ)≈(c₁+c₂ tan(θ)+c₃ tan² (θ))Aₚ(θ), (2d)

where Aₚ(θ) is the projected area function indicating the dependence of the projected frontal area (for the vehicle combination having the new exterior shape) on air-attack angle θ, and where c₁, c₂ and c₃ are shape-parameters that may be kept constant as long as the change of the exterior shape of the vehicle combination 300 only results from a scaling of the overall vehicle combination shape. Using this approach, the drag area function [C_{d}A](θ) is updated through a change in the projected area function Aₚ(θ).

Unless better information is available, the projected area function Aₚ(θ) can be estimated by assuming that the overall shape of the vehicle combination 300 is a cuboid. Such a cuboid 340 is shown in FIG. 3B, and has a height h, a width w, and a length l which match the overall shape of the vehicle combination 300. A side 342 of the cuboid 340 corresponds to a side 322 of the vehicle combination 300, and has a side area Aₛ. Similarly, a front 344 of the cuboid 340 corresponds to a front 324 of the vehicle combination 300 and has a frontal area A_{f}. The side and frontal areas are thus given by Aₛ=1×h and A_{f}=w×h.

FIG. 3C shows the situation in FIG. 3B from above, with the vehicle combination 300 removed leaving only the cuboid 340. The projected frontal area of the vehicle combination 300 is found by projecting the cuboid 340 on a plane 350 perpendicular to the air vector vₐ (i.e. to the air-attack). It is here assumed that the air vector has no vertical component, i.e. that the wind strikes the vehicle directly from the side and not e.g. from below or from above. The projection on the plane 350 is found by extending two lines 352a and 352b perpendicularly from the plane 350, and such that the two lines 352a and 352b touches a respective corner 342a and 342b of the cuboid 340. This results in a parallel projection of the cuboid 340 on the plane and the resulting projected frontal area is provided by the distance l′=l₁+l₂ times the height h of the cuboid. Using trigonometry, it is found that l₁=(A_{f}/h)cos(θ) and l₂=(Aₛ/h)sin(θ), and the projected frontal area is thus provided as

Aₚ(θ)=h×l′=h×(l₁+l₂)=A_{f} cos (θ)+Aₛ sin (θ). (3)

If it is envisaged that a removal or addition of one or more vehicle units (such as trailers or other towed units) only affects the total side area Aₛ of the vehicle combination 300, and leaves the front area A_{f} unchanged, the new projected area function is thus found by modifying Aₛ. In some examples of the envisaged method, a change of the exterior shape of the vehicle combination 300 may include e.g. adding an additional trailer.

FIG. 3D schematically illustrates a top-view of such an example, wherein the change of the exterior shape of the vehicle combination 300 includes adding the additional trailer 314 behind the previous trailer 312. If the additional trailer 314 is added such that the gap between the trailer 312 and the additional trailer is sufficiently small (i.e. such that trailer 312 is shadowing the additional trailer 314), the new projected area function may be found by changing the side area Aₛ above according to Aₛ=Aₛ+Aₛ, where Aₛ*=A_{s,tractor}+Aₛ₁ is the old combined side area of the vehicle combination 300 including only the towing unit 310 (having side area A_{s,tractor}) and trailer 312 (having side area Aₛ₁), and where Aₛ₂ is the side area of the additional trailer 314. This solution assumes that the height h₂ of the additional trailer 314 matches that (h₁) of the trailer 312, and that the frontal area A_{f} of the vehicle combination 300 remains at least approximately the same.

In the above situation, the new projected frontal area (in the air-attack direction) may be defined as

$$\begin{matrix}{A}_{p} ( θ ) = {A}_{f} cos ( θ ) + ( {A}_{s}^{*} + {A}_{s 2} ) sin ( θ ) \\ = {A}_{p}^{*} ( θ ) + {A}_{s 2} sin ( θ )\end{matrix} . \qquad ( 4 )$$

After having estimated the new projected area function Aₚ(θ), the drag area function [C_{d}A](θ) is then estimated using e.g. any of the alternatives provided by equations (2a) through (2d), resulting in an update of the air drag model of the vehicle combination 300 (as provided by equation (1)).

A similar reasoning may of course also be applied if the change of the exterior shape of the vehicle combination 300 instead results from e.g. removing a trailer, thereby reducing the total side area Aₛ of the vehicle combination with an area Aₛ₂ (i.e. by making Aₛ₂ negative).

As envisaged herein, on-line estimation may be used to continuously improve the shape-parameters c₁, c₂ and c₃. For example, if the change of the exterior shape of the vehicle combination 300 is not just a scaling, changes to the shape-parameters c₁, c₂ and c₃ may be required. Such changes may e.g. be based on available information of how the change of the exterior shape impacts the air drag. Exactly how this is performed may depend on the exact model used.

In what follows, a general outline of how to construct a model which is applicable when the change of the exterior shape does not only result in a scaling will now be provided.

For example, it may be assumed that the speed of the air causing the air drag may be divided into two components, namely longitudinal/axial air speed vₐₓ, which is opposite the vehicle (combination) longitudinal direction 302, and lateral/radial air speed v_{ay} which is perpendicular to the vehicle (combination) longitudinal direction 302. The drag area function [C_{d}A](θ)) may then be divided into a shape factor C_{d}(θ) and area projection in air-attack angle Aₚ(θ), i.e. such that

[C_{d}A](θ)=C_{d}(θ) Aₚ(θ). (5)

The shape factor may further be divided into an axial/longitudinal shape factor C_{dx}(θ) affecting the axial/longitudinal air flow, and a lateral/radial shape factor C_{dy}(θ) affecting the lateral/radial air flow. These factors may be approximated as

$${C}_{dx} ( θ ) \approx {c}_{x 1} + {c}_{x 2} \frac{{v}_{ay}}{{v}_{a x}} \qquad ( 6 a )$$

$$and$$

$${C}_{dy} ( θ ) \approx {c}_{y 1} + {c}_{y 2} \frac{{v}_{a x}}{{v}_{a y}} , \qquad ( 6 b )$$

where cₓ₁ defines the axial/longitudinal shape factor when there is no lateral/radial air flow, cₓ₂ defines the how the lateral/radial air flow affects the axial/longitudinal shape factor, c_{y1} defines the lateral/radial shape factor when there is no axial/longitudinal air flow, and where c_{y2} defines how the axial/longitudinal air flow affects the lateral/radial shape factor. The air drag force Fₐ may then be written as a sum of an air drag Fₐₓ from the axial/longitudinal air flow and an air drag F_{ay} from the lateral/radial air flow, i.e. as

Fₐ=Fₐₓ+F_{ay}. (7)

The air drag from the axial/longitudinal air and air drag from the lateral/radial air may be written as

Fₐₓ=0.5ρAₚ(θ)C_{dx}(θ)vₐₓ² (8a)

and

F_{ay}=0.5ρAₚ(θ)C_{dy}(θ)v_{ay}². (8b)

The parameters c₁, c₂ and c₃ may then be calculated as

c₁=cₓ₁A_{f}, (9a)

c₂=cₓ₂A_{f}+c_{y2}Aₛ, (9b)

and

c₃=cy₁Aₛ. (9c)

Using this modified approach, when the exterior of the vehicle combination is changed in a way similar to scaling, the parameters c₁, c₂ and c₃ may be adjusted according to equations (9a-c) with the parameters cₓ₁, cₓ₂, c_{y1} and c_{y2} unchanged and only adjusted according to changes in A_{f} and Aₛ. On the other hand, if the exterior change is more related to the shape factors, like e.g. when changing an air deflector setting or adding a cover on the side of the vehicle combination in e.g. an attempt to reduce the effects of crosswind-generated air drag, A_{f} and Aₛ may be left unchanged and c₁, c₂ and c₃ may be adjusted to the changes in cₓ₁, cₓ₂, c_{y1} and c_{y2}. An exterior change may of course also be such that it causes both a change in scale and a change in scale factors, in which case the parameters c₁, c₂ and c₃ may be adjusted both by changing A_{f} and Aₛ and also cₓ₁, cₓ₂, c_{y1} and c_{y2}.

In some embodiments, some of the parameters cₓ₁, cₓ₂, c_{y1} and c_{y2} may not be needed (and e.g. be assumed to be zero). It is envisaged to use any combination of parameters, although it is often likely that cₓ₁ is to be included for most applications, and that also at least one or more of the other tree parameters (or a function of them) cₓ₂, c_{y1} and c_{y2} are needed if crosswind sensitivity is to be taken into account.

Importantly, even if consider scaling-only or taking other shape-changes into account, estimating of a side area Aₛ of the vehicle combination remains important, and is provided by using the one or more images of the vehicle combination 300 as envisaged herein.

With reference to FIGS. 4A and 4B, various embodiments of a device as envisaged herein will now be described in more detail.

FIG. 4A schematically illustrates, in terms of a number of functional units, the components of an embodiment of a device 400. The device 400 may e.g. be provided and used in the towing unit 310 (vehicle), or in other parts of the vehicle combination 300. The device 400 may also form part of some other equipment which may communicate with a camera used to capture the one or more images of the vehicle combination 300, such as e.g. the smartphone/table 372, the drone 372, or similar. In a preferred embodiment, the device 400 forms part of the vehicle combination 300, and preferably forms part of the towing unit 310.

The device 400 includes processing circuitry 410. The processing circuitry 410 is provided using any combination of one or more of a suitable central processing unit (CPU), multiprocessor, microcontroller, digital signal processor (DSP), etc., capable of executing software instructions stored in a computer program product (not shown, but envisaged herein) stored on a storage medium 420. The processing circuitry 410 may further be provided as at least one application specific integrated circuit (ASIC), or field-programmable gate array (FPGA), or similar.

Particularly, the processing circuitry 410 is configured to cause the device 400 to perform a set of operations, or steps, such as one or more of steps S101-S104 as disclosed above e.g. when describing the method 100 illustrated in FIG. 1. For example, the storage medium 420 may store a set of operations, and the processing circuitry 410 may be configured to retrieve the set of operations from the storage medium 420 to cause the device 400 to perform the set of operations. The set of operations may be provided as a set of executable instructions. Thus, the processing circuitry 410 is thereby arranged to execute methods as disclosed herein e.g. with reference to FIG. 1.

The storage medium 420 may also include persistent storage, which, for example, can be any single or combination of magnetic memory, optical memory, solid state memory or even remotely mounted memory. The storage medium 420 may thus provide non-transitory storage, storing computer-readable instructions for the processing circuitry 410.

The device 400 may further include a communications interface 430 for communications with other entities and objects, in order to e.g. receive/obtain one or more of images of the vehicle combination used to estimate the projected area function Aₚ(θ), and/or to e.g. detect the change of the exterior shape of the vehicle combination 300. The communications interface 430 may also be configured to e.g. receive information about the one or more cameras needed to estimate e.g. the side area Aₛ₂ of an added trailer, or e.g. predicted weather information, if the estimated air drag model of the vehicle combination 300 is to be used to e.g. predict an energy consumption while driving along a route for which the predicted weather information is pertinent. The interface 430 may also be used to receive other information about the vehicle combination 300. In other embodiments of the device 400, information about the vehicle combination 300 (such as e.g. information about one or more cameras 360a-360c, their positions relative to the vehicle combination 300, focal lengths of lenses, image sensor sizes, crop-factors, aspect ratios, a homography used for perspective correction, etc.), and/or the weather information may e.g. be stored within the device 400 itself, for example using the storage medium 420. The communication interface 430 may include one or more transmitters and receivers, including analogue and/or digital components, and may utilize e.g. one or more wired and/or wireless connections for this purpose.

The processing circuitry 410 controls the general operation of the device 400 e.g. by sending data and control signals to the communications interface 430 and the storage medium 420, by receiving data and reports from the communications interface 430, and by retrieving data and instructions from the storage medium 420. The device 400 may of course optionally also include other components, here illustrated by the dashed box 440. A communication bus 450 is also provided and connects the various modules/units 410, 420, 430, and 440 (if included), such that they may communicate with each other to exchange information.

FIG. 4B schematically illustrates, in terms of a number of functional modules 401-404 (where the module 404 is optional), the components of a device 400 according to one or more embodiments of the present disclosure. The device 400 includes at least a detect module 401 configured to perform step S101 of the method 100 described with reference to FIG. 1, an estimate module 402 configured to perform step S102 of the method 100, and an update module 403 configured to perform step S103 of the method 100. In some embodiments, the device 400 may also include a use module 404 configured to perform step S104 of the method 100 described with reference to FIG. 1.

In general terms, each functional module (such as modules 401-404) may be implemented in hardware or in software. Preferably, one or more or all functional modules may be implemented by the processing circuitry 410, possibly in cooperation with the communications interface 430 and/or the storage medium 420. The processing circuitry 410 may thus be arranged to from the storage medium 420 fetch instructions as provided by one or more of the functional modules (e.g. 401-404), and to execute these instructions and thereby perform any steps of the method 100, or any other method envisaged herein, performed by the device 400 as disclosed herein.

In some embodiments, the device 400 may further include additional functional modules (not shown), as needed to perform one or more methods as envisaged herein.

The present disclosure also envisages to provide a vehicle or vehicle combination (such as e.g. the towing unit 310 or vehicle combination 300), where the vehicle or vehicle combination includes the device 400 as described with reference to FIGS. 4A and 4B.

The present disclosure also envisages to provide a computer program for estimating air drag of/for a vehicle combination. The computer program includes computer code that, when running on a processing circuitry of a device (such as e.g. the processing circuitry 410 of the device 400 described with reference to FIGS. 4A and 4B), causes the device to perform the various steps of any method (such as e.g. method 100) as described and envisaged herein.

The present disclosure also envisages a computer program product (not shown) in which the above envisaged computer program is stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention, from a study of the drawings, the disclosure, and the appended claims.

In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

In summary of the present disclosure, it is provided an improved way of handling a situation in which an exterior shape of a vehicle combination changes, and where an air drag model of the vehicle combination can be updated automatically after detecting such a change, using one or more images of the vehicle combination to estimate a new projected area function Aₚ(θ). This facilitates e.g. performing of transport missions along a route which includes one or more changes to the exterior shape of the vehicle combination (such as a pick-up/drop-off of one or more trailer units). This in contrast to commonly available technology, wherein the drag area of the changed vehicle combination must either be obtained by on-line estimation, wind tunnel tests/experiments, numerical simulations, and/or by tabular values.

1. A computer-implemented method of estimating air drag of a vehicle combination, the method comprising:
detecting a change of an exterior shape of the vehicle combination to a new exterior shape;
in response to detecting such a change, based on one or more images of the vehicle combination captured after the change of the exterior shape, estimating a projected area function (Aₚ(θ)) indicating a dependence of a projected frontal area of the vehicle combination having the new exterior shape on air-attack angle (θ), and
using the estimated projected area function to update a crosswind-sensitive air drag model for the vehicle combination.

2. The method according to claim 1, wherein the method includes initiating a capture of the one or more images in response to said detecting.

3. The method according to claim 1, wherein the method includes receiving the one or more images from at least one camera mounted to/on the vehicle combination.

4. The method according to claim 1, wherein estimating the projected area function includes estimating a side area (Aₛ) of the vehicle combination after the change of the exterior shape.

5. The method according to claim 4, wherein the one or more images depict at least part of a side of the vehicle combination.

6. The method according to claim 4, wherein estimating the projected area function includes estimating the projected frontal area after the change of the exterior shape as a projected area of a cuboid on a plane perpendicular to air-attack (vₐ).

7. The method according to claim 1, wherein the method further includes detecting the change of the exterior shape based on the one or more images of the vehicle combination.

8. The method according to claim 1, wherein detecting the change of the exterior shape includes at least one of receiving a signal from a user interface of the vehicle combination, receiving a signal indicative of a change in air deflector settings, and receiving a signal indicative of a trailer being either connected or detached from the vehicle combination.

9. The method according to claim 1, wherein the method further includes receiving predicted wind information pertinent to a particular route, and using the updated air drag model for at least one of energy management, range estimation, vehicle combination dynamics, and cruise control, of the vehicle combination along the particular route.

10. A device for estimating air drag of a vehicle combination, comprising processing circuitry configured to cause the device to:
detect a change of an exterior shape of the vehicle combination to a new exterior shape;
in response to said detection, based on one or more images of the vehicle combination captured after the change of the exterior shape, estimate a projected area function (Aₚ(θ)) indicating a dependence of a projected frontal area of the vehicle combination having the new exterior shape on air-attack angle (θ), and
use the estimated projected area function to update a crosswind-sensitive air drag model for the vehicle combination.

11. The device according to claim 10, wherein the processing circuitry is further configured to cause the device to perform the method.

12. A vehicle or vehicle combination, comprising a device according to claim 10.

13. A computer program for estimating air drag of a vehicle combination, the computer program comprising computer code that, when running on processing circuitry of a device, causes the device to:
detect a change of an exterior shape of the vehicle combination to a new exterior shape;
in response to said detection, based on one or more images of the vehicle combination captured after the change of the exterior shape, estimate a projected area function (Aₚ(θ)) indicating a dependence of a projected frontal area of the vehicle combination having the new exterior shape on air-attack angle (θ), and
use the estimated projected area function to update a crosswind-sensitive air drag model for the vehicle combination.

14. The computer program according to claim 13, wherein the computer code is further such that it, when running on the processing circuitry of the device, causes the device to perform the method.

15. A computer program product comprising a computer program according to claim 13, and a computer-readable storage medium on which the computer program is stored.
